(19) United States
(12) Patent Application Publication
(10) Pub. No.: US 2013/0251261 A1
(43) Pub. Date: Sep. 26, 2013

(54) Method And Apparatus For Image Data Compression

(71) Applicant: MARVELL WORLD TRADE LTD., St. Michael (BB)

(72) Inventor: Daniel Blum, Corvallis, OR (US)

(73) Assignee: Marvell World Trade Ltd., St. Michael (BB)

(21) Appl. No.: 13/848,126

(22) Filed: Mar. 21, 2013

Related U.S. Application Data
(60) Provisional application No. 61/614,847, filed on Mar. 23, 2012.

(51) Int. Cl. G06T 9/00

(52) U.S. Cl. CPC G06T 9/00
USPC 382/176; 382/173

(57) ABSTRACT

A method and corresponding apparatus are for compressing image data of an image. The method includes splitting the image data into regions, including a first region and a second region. The method further includes determining a first compression scheme to be used in encoding the image data of the first region and a different second compression scheme to be used in encoding the image data of the second region. The method further includes applying the first compression scheme to the image data of the first region and the second the compression scheme to the image data of the second region. For each region, the determining and the applying are iteratively performed to yield first resulting compressed region data for the first region and second resulting compressed region data for the second region.

### CROSS-REFERENCE TO RELATED APPLICATION

This application claims priority from U.S. Provisional Application No. 61/614,847, filed Mar. 23, 2012, hereby incorporated herein by reference.

### TECHNICAL HELD

This application relates to image data compression, used in image processing of still images and images in streaming video.

### BACKGROUND

Image processing applications can be applied to still images and images in streaming video. Data representing the images can be stored, displayed or printed. In such applications, it can be advantageous to compress the image data in order to reduce the amount of storage space required to store the images and the amount of time required to communicate the images from one device to another.

### SUMMARY

The present disclosure relates to a method and corresponding apparatus for compressing image data of an image. The method includes splitting the image data into regions, including a first region and a second region. The method further includes determining a first compression scheme to be used in encoding the image data of the first region and a different second compression scheme to be used in encoding the image data of the second region. The method further includes applying the first compression scheme to the image data of the first region and the second the compression scheme to the image data of the second region. For each region, the determining and the applying are iteratively performed to yield first resulting compressed region data for the first region and second resulting compressed region data for the second region.

The determining can include determining respective compression schemes for all of the regions of the image data, and the applying can include applying the respective compression schemes to all of the regions of the image data. The iteratively performing can include iteratively performing the determining and the applying until the compressed image data for the entire image is at or below a (predetermined threshold file size value. The splitting, determining, applying and iteratively performing can be performed for each image of a video stream of images or of a series of still images to be printed or displayed, with the predetermined threshold file size value being the same for all of the images in the stream or series.

The applying of the first compression scheme can be performed by a first encoding channel. The applying of second the compression scheme can be performed by a second encoding channel that is separate from the first channel. The method can include applying, by a first decoding channel, a first decompression scheme to the first resulting compressed region data, and applying, by a second decoding channel that is separate from the first decoding channel, a second decompression scheme to the second resulting compressed region data. The first and second decompression schemes can respectively correspond to the first and second compression schemes.

### BRIEF DESCRIPTION OF THE FIGURES

FIG. 1 is a block diagram of a system for compressing and transferring an image.

FIG. 2 is an example image that can be processed using the system of FIG. 1.

FIG. 3 is a flowchart of a method that can be implemented by the system of FIG. 1.

FIG. 4 is a block diagram of system for compressing and storing an image.

### DETAILED DESCRIPTION

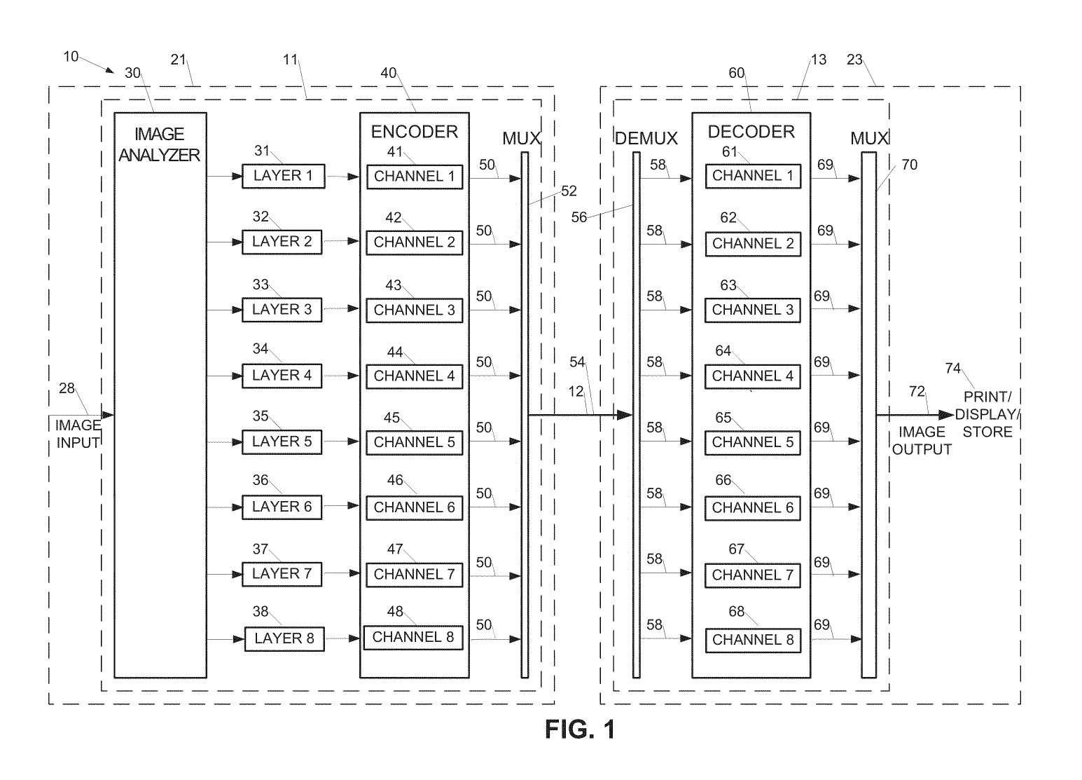

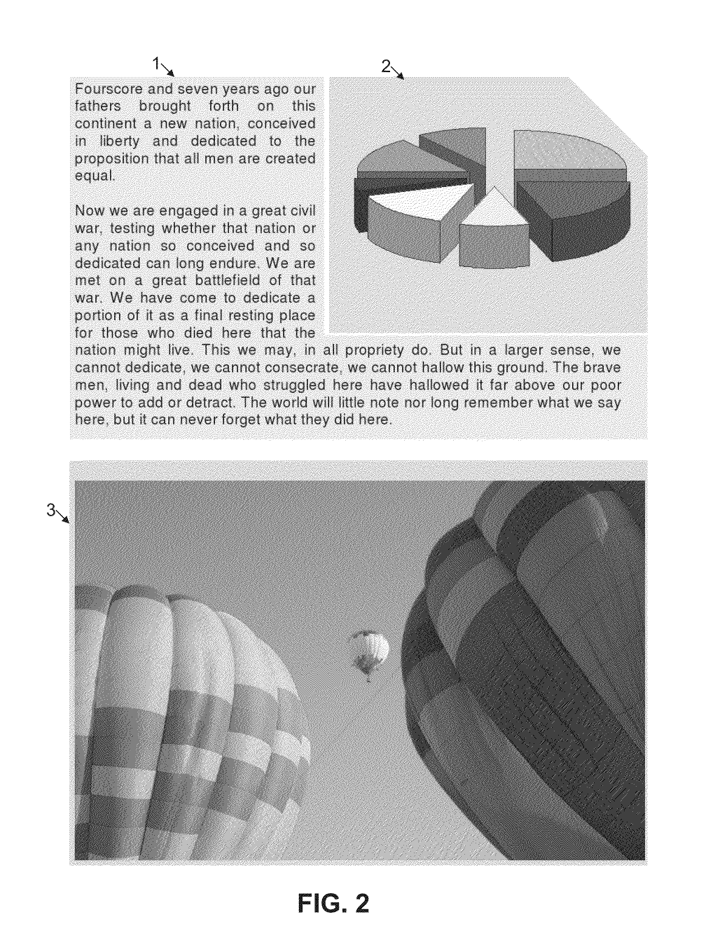

FIG. 1 is a block diagram of an example image processing system 10 for processing an image. The system 10 includes an encoding section 11 that compresses image data, a communication link 12 that outputs the image data, and a decoding section 13 that decompresses the image data. An example image, as illustrated in FIG. 2, can include different regions that have different characteristics. In this example, the regions are a first region 1 of text, a second region 2 of non-text lower-complexity graphics, and a third region 3 of non-text high -r-complexity graphics. The encoding section 11 of FIG. 1 splits the image into regions and compresses the image data of each region with a different compression scheme that is optimized for that particular region's characteristics. The decoding section 13 later decompresses the compressed data separately for each region based on the particular compression scheme used for the respective region.

In the example of FIG. 1, the encoding section 11 is within an image transmitting device 21, for example a computer or a network server. The decoding section 13 is within an image receiving device 23, for example a printer, a video player, a computer, or a data storage device (e.g., a hard drive).

In this example, the encoding section l 1 includes an input 28 for inputting the images. The images can be in a series of still images to be stored, or to be transmitted, displayed or printed in rapid succession. The images could also be in a stream of images in a video to be transmitted or stored.

The encoding section l 1 can also input and store a threshold file size value representing a maximum allowable value for a compressed file size to have. The threshold file size value can be in terms an amount of data, such as a number of bytes, that would be used to transmit the image over the communication section or to store the image in memory. For example, an input image file size can be 100 MB (megabytes), with a threshold file size value of 10 MB, so that an overall image compression ratio would be 10. In a series of still images or a stream of images in a video, the threshold file size value can be set to the same value for all images in the series or stream. Accordingly, a file size of each image in the series or stream may be the same as or less than the threshold file size value but may not be greater than the threshold file size value.

The encoding section 11 would not be designed to compress all images in the series or stream by the same compression ratio (initial file size divided by final file size) or quality factor. The encoding section 11 would instead compress each image by an amount needed for the file size of the compressed image to be at or below the threshold file size value.

In an example where streaming video is being displayed as it is being downloaded over the communication link 12, the threshold file size value can be set to avoid (e.g., reduce or eliminate) an occurrence of periodic video freezes. To avoid the occurrence of video freezes, the threshold file size value can be a positive function of the bandwidth or Internet download speed of the communication link 12 (higher for video transmission speeds and lower for lower video transmission speeds). Where higher transmission speed is available, basing the threshold file size value on transmission speed results in a lower overall compression ratio for an image and thus lower image detail loss. For lower transmission speed, basing the threshold file size value on transmission speed results in a higher overall compression ratio for the image and thus greater image detail loss in order to avoid display freezes. Basing the threshold file size value on transmission speed can ensure transmission of a minimum number of images per unit time, which is advantageous for video and high-speed printing.

The encoding section 11 includes an image analyzer 30 that divides the image into regions. The analyzer 30 analyzes each region to determine which compression scheme—encompassing compression method, compression ratio and/or quality factor—should be applied. The determination is customized for each region and is based on which compression scheme will result in an optimized balance of overall image quality and overall compression ratio for achieving the threshold file size. The determination can be based on analysis of features of the image to be compressed without regard to features of other images that precede or follow in the image series or video stream.

The sizes and/or shapes of the different regions can be the same for all regions. Alternatively, the sizes and shapes can differ between regions, and can be dynamically determined by the analyzer 30 based on analysis of the image. The regions can be rectangular, including square such as blocks of 8×8 pixels. Alternatively, or re or more of the regions can match a shape of a feature of the image, such as a shape of a human face or text character in the image. Then, the face or character can be compressed using a different compression scheme, or a different combination or sequence of compression schemes, than other regions of the image.

The image analyzer 30 categorizes each region based on a number of and variation of colors in the region, the number of and variation of hues of a color, a level of detail in the region, and sharpness of detail. In the example shown in FIG. 1, the analyzer 30 categorizes each region into three region types: bilevel, lower detail contone, and higher detail contone. Bilevel is where the pixel are completely or substantially of two colors or two levels of the same color, which is typical of text. Contone is where the pixels have multiple colors or hues, which is typical for a picture, such as a photograph. Lower detail is exemplified by gradual variation in hue along a horizontal or vertical direction. Lower detail is typical of color shading in a common three-dimensional-simulated pie chart generated by a statistical analysis program. Higher detail is exemplified by a large color gradient indicated by a sharp change in color from one pixel to the next. Higher detail is further exemplified by a significant change in color gradient from pixel block to the next, which is typical of a photograph.

The regions of an image can be divided among any number of different layers, with each layer containing regions of a common category. The example of FIG. 1 has eight layers 31-38, each successively lower layer having successively the same or more complexity. A first layer 31 includes regions that are substantially text. A second layer 32 includes regions that are substantially bilevel red. A third layer 33 includes regions that are substantially bilevel blue. A fourth layer 34 can include regions whose selection of colors is limited to a set number of palette colors. The colors in the palette can be dynamically assigned by the analyzer 30 based on analysis of the region at hand. A fifth layer 35 includes regions that are lower-detailed contone. A sixth layer 36, a seventh layer 37 and an eighth layer 38 all contain higher-detail contone regions, with each successively lower layer (in going from sixth to eighth) having regions of successively greater detail.

In the above example, each region is assigned to only one layer. Alternatively, a single 8×8 pixel region might be separated into two or more 8×8 pixel region overlays, and the overlays can be assigned to different layers despite being components of the same region. The separation can be based on an image detail such as text, shape and/or color. In a first example of the overlay approach, one overlay of a region can have the region's text and another overlay of the region can have non-text contone. The text overlay can be assigned to a first layer and the non-text region can be assigned to a second layer. In a second example of the overlay approach, one overlay can contain the red component of each pixel in the region and the second overlay can contain the blue component of each pixel of the same region. The red overlay can be assigned to the second layer and the blue overlay can be assigned to the third layer.

The analyzer 30 can be implemented by software instructions that are stored in a storage medium of the encoding suction 11 of the transmitting device 21 and executed by a processor of the encoding section 11 of the transmitting device 21 to implement the functions of the image analyzer 30. Alternatively, the image analyzer 30 can be in the form of application specific hardware.

The encoding section 11 includes an encoder 40 that encodes each layer with a compression method assigned specifically to that level. In the example of FIG. 1, the first, second, third and fourth layers 31, 32, 33, 34 are compressed using JBIG. The fifth layer 35 is compressed with a lossless compression method, such as run length encoding (RLE), PackBits, LZW and GZIP. The sixth, seventh and eighth layers 36, 37, 38 are compressed with a lossy compression method, such as JPEG, and with successively higher quality factors (such as 70%, 80% and 90%, respectively) and/or successively higher compression ratios (such as 1:5, 1:10, and 1:20 respectively). The lossy compression method can be different for each of the lowest three layers (sixth through eighth). In the lossy compression methods, nearest neighbors may be averaged and similar adjacent segments combined.

A bilevel layer and a palette layer can be configured to preserve text and “colorimetric” logo colors, and potentially bypass CSCs and other image processing. Software in the image transmitting device can tag the pixels/colors/regions to place in these layers, or the codec can simply select the most frequently appearing pixels.

Faces and skin tone regions may be tagged by the image transmitting device 11 or by an image capture device that transmitted the image to the image transmitting device 11. Faces and skin tone might receive less compression and avoid image processing that may do harm to these areas. On the other hand, additional compression can be added to background and out-of-focus areas. The image capture device may record focus values for all regions and tag them. Embedded objects in the image may specify the compression parameters (regarding scheme and quality) for layers in which embedded objects are to be placed.

While frequently occurring pixels and long segments are placed into higher-level lossless layers, more complex regions are placed into lossy layers. A higher degree of lossy compression can be applied to segments with less contrast, which would be less noticeable to a human observer. Channel bandwidth and memory thresholding requirements are applied to the process of mapping regions into compression layers. The overall complexity, average run-length, and frequency response of a document are major variables in the calculation of how many layers must be used and how much data must be in each layer. Some regions, such as those containing embedded objects, line art, logos and other important data, may be assigned to a higher-level layer to be given minimal loss or lossless compression, or may pass through the encoder or bypass the encoder without any compression.

The regions can be selectively compressed based on a number of factors, including image complexity, frequency response, average run length, viewer sensitivity to potential artifacts, and bandwidth availability. For text and the most frequently occurring pixel values, bilevel or palette encoding can be used in combination with lossless JBIG (or similar) compression. For text and the most frequently occurring pixel values, bilevel or palette encoding can be used in combination with lossless JBIG (or similar) compression. The palette colors can be dynamically assignable based on analysis of the input image. After all available palette channels are used, the next layer can receive a form of lossless compression (RLE, PackBits, LZW, GZIP, etc.) for regions of high sensitivity, acceptable compressibility, and sufficient available bandwidth. The subsequent layer may be compressed with a slightly lossy compression, where nearest neighbors may be averaged, similar adjacent segments combined, etc. Remaining regions requiring lossy compression can then be JPEG encoded, with quality factor depending on the remaining bandwidth. It can be possible to utilize multiple JPEG layers, each with a different quality factor and compression ratio.

The iterative approach of analyzing and compressing regions individually may guarantee that memory and bandwidth usage is limited to specified maximum threshold per image. A run-length, DCT frequency response, or other complexity analysis profile is performed over the entire page or frame, and it is separated into layers based upon the result. Alternatively, the entire image can be first compressed losslessly, and areas with the lowest level of compression may be iteratively recompressed until the output size is below the desired threshold. Ultimately, the most frequently occurring pixels and least complex regions are placed into higher layers, and the regions with the most variations and highest complexity are placed into in lower layers. Compression becomes increasingly lossy as data moves to lower layers, allowing for a higher compression ratio and lower bandwidth utilization.

The analyzer 30 may take into account complexity analysis, segment run lengths, DCT frequency response, and/or region tagging by higher level applications. The encoding section 11 may generate a first-pass lossless contone layer while calculating the run-length profile. This can allow computations and memory accesses for these two operations to be shared. Bitmaps or other objects that are embedded in documents may be passed straight to lower layers. These objects should not be decoded and promoted to higher layers. Alternatively, the objects may be recompressed to lower layers if necessary for bandwidth considerations. The extraction of data into the high-level bilevel/palette layers may be performed in a number of ways. The most straightforward would be to place pixels occurring most frequently into these channels.

A few flags per pixel may be maintained for region identification. Text, images, graphics, and other areas may be enhanced by hardware, mapped directly to specific colors, or filtered with specific algorithms (smoothing, sharpening, etc). Additionally, these regions may be tagged with specific compression types applied (e.g. lossless text and lossy images), which may be used as an aide to improving compression efficiency and perceived image quality.

The encoder 40 can be implemented by software instructions that are stored in a storage medium of the encoding section 11 of the transmitting device 21 and executed by a processor of the encoding section 11 of the transmitting device 21 to implement the functions of the encoder 40. Alternatively, the encoder 40 can be in the form of application specific hardware that is specifically configured for compression. The encoder software or hardware can include, for each layer 31-38, a separate encoder channel 41-48 (or encoder stage) that functions as an independent encoder so that the eight layers can be encoded simultaneously. In that case, the compressed data can be output from the encoder 40 in eight parallel output data streams 50, one output data stream 50 for each of the parallel encoder channels 41-48.

The encoding can be performed iteratively in the following way. The image's raw image data may be compressed in a first iteration as explained above, by the analyzer 30 splitting the image into regions and the encoder 40 compressing the regions with different compression schemes. Then, the analyzer 30 may determine whether the first compression iteration reduced the image file size to a value at or below the threshold value. If not, then the compression would he repeated in a second iteration. The aforementioned compressing and determining can be iteratively repeated until the image file size is reduced to a value at or below the threshold value.

In a first example procedure, in each successive iteration, each region would remain in the same layer it was previously in. In that case, the data that was compressed in a previous iteration would he compressed further in the next iteration. The final iteration can result in a given region having been repeatedly compressed multiple times with different compression methods and different compression ratios.

In a variation of the first example procedure, if the analyzer 30 determines after one iteration that a region's data needs to be compressed to a smaller size, the compressed data is discarded and in the next iteration the encoder 40 would apply another compression scheme—a different method or the same method with a different compression ratio—to the original raw data to achieve a higher compression ratio.

In a second example procedure, in each successive iteration, the analyzer 30 analyzes each region's compressed data and determine whether to move the region to another layer having a different compression scheme—with a different compression ratio, a different quality factor and/or even a different compression method. In the next iteration, the previous compression data is discarded and the different compression scheme is performed on the original raw data. When moving a region to a different layer for the next iteration, the region would preferably move down a level, instead of up a level, to apply a compression scheme that is lossier than the previously used method.

In a variation of the second example procedure, the different compression ratio and/or different compression method is applied to the resulting data of the previous compression. In that case, the final iteration can result in image data that has been compressed multiple times using different compression schemes (with different compression method and different compression ratio and quality factor). The final iteration can therefore result in the final data of each region having been compressed with a different combination and sequence of compression schemes than the data of other regions of the image.

In a third example procedure, the entire image is first compressed losslessly, and areas with the lowest level of compression are iteratively recompressed until the output size is at or below the threshold file size value. Regions with the most frequently occurring pixels and least complex regions are placed into higher layers. Regions with the most variations and highest complexity are placed into in lower layers.

In a fourth example procedure, the encoder compresses only one subset of the layers at a time, starting with a top subset of layers and working its way downward to successively lower subsets of layers. Each subset can have as few as one layer. After compressing each subset, the analyzer 30 determines whether the threshold file size has been reached. If it has, then the lower layers do not have be compressed and compression ceases. Since the upper layers are lossless, this fourth example procedure can avoid the application of lossy compression where it would not be needed. This fourth example procedure can also reduce processing time and computing resources by avoiding more complex methods when the more complex methods are not needed to reach the threshold file size.

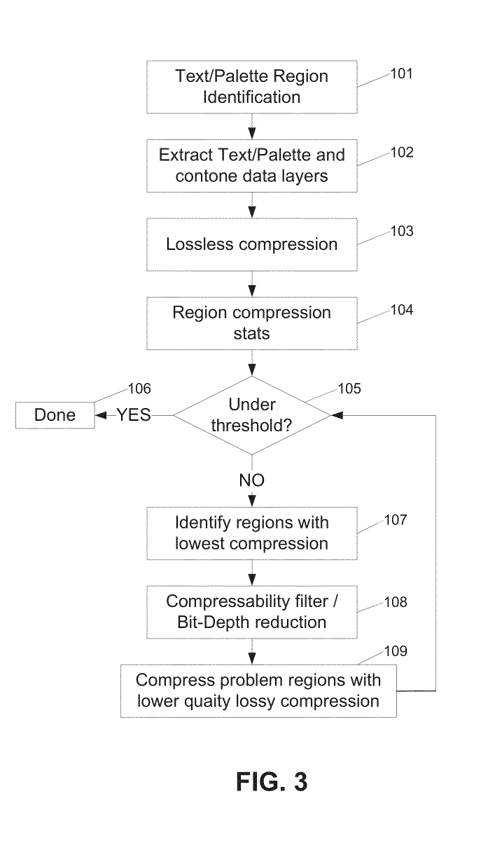

A fifth example procedure is illustrated by a flowchart in FIG. 3. In the flowchart, the analyzer 30 identifies 101 text and palette color (line art, logo, frequent colors) regions of interest. The analyzer 30 then separates 102 contone and text/palette into distinct layers. The encoder 40 performs 103 lossless compression on each layer (e.g., RLE or LZW method on contone, and JBIG method on text/palette). The analyzer 30 then captured 104 compression stats on N×N regions and/or performs a complexity analysis on the entire image. The analyzer 30 compares 105 the compressed image file size to a threshold file size value. If the lossless compressed image is less than the threshold file size value, then no further compression is called for and the procedure is done 106. However, if the lossless compressed image above the threshold file size value, then the analyzer 30 proceeds to identify 107 regions with lowest compression factor (number of regions selected is based on how far the image data is over the threshold file size). The encoder 40 can apply 108 a compressibility filter (bit-depth reduction and/or merging of similar neighboring segments). The encoder compresses 109 regions with high quality JPEG. The procedure flow then returns to 105 where the analyzer determines whether to repeat 107-109 with the lowest compression ration regions in an iterative fashion, using successively lower quality JPEG for each successive iteration.

The number of regions can be dynamically determined, by the analyzer 30, based on analysis of the image. The analyzer 30 might designate the entire image as a single region to be iteratively compressed with a sequence of different compression schemes. For example, the analyzer 30 may color-separate the entire image into overlays, such as a red overlay of the entire image and a non-red (yellow plus blue) overlay of the entire image. The analyzer 30 can then send the different overlays to different layers to be compressed using different compression schemes or different combinations or sequences of compression schemes.

The compressed data is output through multiple compressed parallel streams 50 from the encoder 40, one parallel stream for each encoder channel 41-48. The compressed output streams 50 in the example of FIG. 1 are merged by a multiplexer 52 into a single compressed serial output stream 54. The serial output stream 54 may be channeled by the communication link 12 to the decoding section 13 in the image receiving device 23. Alternatively, the compressed output data (through lines 50) may be transmitted through the communication 12 while still in parallel form without being merged. Examples of the communication link 12 are a communication link through a wired or wireless network such as over the Internet, a parallel or serial cable, or a parallel or serial electrical connection within the sending device 21 itself such as an electrical line from a processor of the sending device to a data storage device within the sending device 21.

In the output stream 54, the compressed data for each layer can be interleaved with data of other layers. For example, the multiplexer 52 can output a first set of lines from each of the layers 31-38, and then output a second set of lines from each of the layers 31-38, and then output a third set of lines from each of the layers 31-38. Alternatively, all lines from a given layer are output together, before any lines of a next layer are output.

During the merging of output streams 50, the regions are reassembled to reconstruct data representing the entire image. If two layers are found to provide data for the same region, resulting in a conflict, a higher level layer would have priority over a lower level layer.

In the example of FIG. 1, the receiving device 23 is external to the sending device 13 and receives the compressed data 54 through a serial connection 12. (e.g, USB). Since, in this example, the received data stream is serial, a demultiplexer 56 deserializes the data stream back into multiple parallel data streams 58 of the compressed data.

A decoder 60, within the decoding section 13 of the image receiving device 23, decompresses the compressed data streams 58. The decoder 60 can be implemented by soft /are instructions that are stored in a storage medium of the decoding section 11 of the receiving device 21 and executed by a processor of the decoding section 11 of the receiving device 21 to implement the functions of the decoder 60. Alternatively, the decoder 60 can be in the form of application specific hardware specifically configured for decompression.

The decoder 60 can include, for each layer, a separate decoder channel 61-68 that functions as an independent decoder, so that the eight layers can be decoded simultaneously. Each of the parallel decoder channels 61-68 can mirror a corresponding one of the multiple parallel encoder channels 31-38. The decoder 60 can therefore decompress the data of each region in accordance with the compression scheme, or combination or sequence of schemes, used to compress the data of that region. The compressed data of each region is thus decompressed by the decoder 60 using different decompression schemes that respectively correspond to and mirror the compression schemes used to compress the data of that region.

The decoded data is output as multiple output streams 69 through respective multiple output data lines, one output stream 69 for each of the parallel decoders 61-68. A multiplexer 70 merges the output data streams 69 into a single decompressed output data stream 72. The data stream 72 is processed 74, for example printed such as by a printer, displayed such as by a video monitor, or stored such as by a hard drive.

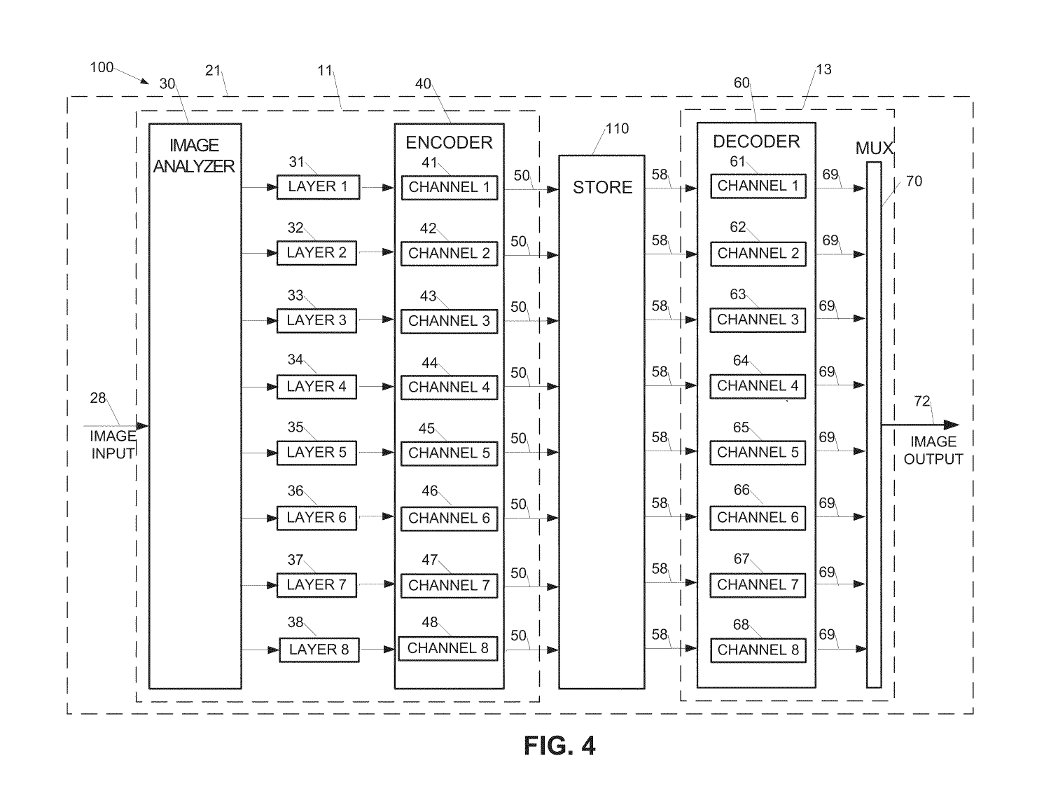

Another example image processing system 100 is shown in FIG. 4. This system 100 has components that are equivalent to components of the system of FIG. 1 and are assigned the same reference numerals as assigned in FIG. 1. In the system of FIG. 4, both the encoding section 11 and the decoding section 13 are parts of the same device 21, in this example a computer. When the encoding section 11 receives image data through the input 28, it compresses the image data into compressed output data streams 50 in a manner described above. The compressed output data 50 is stored in a data storage device 110, such as a hard drive, of the computer 21. The output data streams 50 can be merged before being stored, such as described above. Alternatively, the data streams 50 can be stored without merging. At a later time, when the image data is requested by an application of the computer 21, the decoder 60 reads the data from the storage device 110 and decodes it to output decompressed data streams 69 in a manner described above. The streams 69 can then be merged by the multiplexer 60 for use by the computer application.

This written description uses examples to disclose the invention, including the best mode, and also to enable a person skilled in the art to make and use the invention. The patentable scope of the invention may include other examples. Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein. Other implementations may also be used, however, such as firmware or even appropriately designed hardware configured to carry out the methods and systems described herein,

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, Flash memory, flat files, databases, programming data structures, programming variables, IF-THEN (or similar type) statement constructs, etc.). It is noted that data structures describe formats for use in organizing and storing data in databases, programs, memory, or other computer-readable media for use by a computer program.

1. A method for compressing image data of an image, the method comprising:
splitting the image data into regions, including a first region and a second region;
determining a first compression scheme to be used in encoding the image data of the first region and a second compression scheme, different than the first compression scheme, to be used in encoding the image data of the second region;
applying the first compression scheme to the image data of the first region and the second compression scheme to the image data of the second region; and
iteratively performing, for each of the first region and the second region, the determining and the applying to yield first resulting compressed region data for the first region and second resulting compressed region data for the second region.

2. The method of claim 1, wherein the first compression scheme is lossless and the second compression scheme is lossy.

3. The method of claim 1, wherein the determining includes determining respective compression schemes for all of the regions of the image data, wherein the applying includes applying the respective compression schemes to all of the regions of the image data, and wherein the iteratively performing includes iteratively performing the determining and the applying until the compressed image data for the entire image is at or below a predetermined threshold file size value.

4. The method of claim 3, wherein the splitting, the determining, the applying and the iteratively performing are performed for each image of a video stream of images, and wherein the predetermined threshold file size value is the same for all of the images in the video stream.

5. The method of claim 3, wherein the splitting, the determining, the applying, and the iteratively performing are performed for each image of a series of still images to be printed or displayed, and wherein the predetermined threshold file size value is the same for all of the images in the series,

6. The method of claim 1, wherein, for the first region, at least one iteration of the determining includes determining a compression scheme based on a different compression method, with a different compression ratio, than was determined for the same region in a previous iteration of the determining.

7. The method of claim 1, wherein, for the first region, each iteration of the applying includes applying the determined compression scheme to data resulting from a previous iteration of the applying for the first region.

8. The method of claim 1, wherein, for each of the first and second regions, the determining of the compression scheme to be applied to the respective region is based on complexity of the region.

9. The method of claim 1, wherein, for each of the first and second regions, the determining of the compression scheme to be applied to the respective region is based on whether the region includes text.

10. The method of claim 1, wherein the applying of the first compression scheme is performed by a first encoding channel, wherein the applying of second the compression scheme is performed by a second encoding channel that is separate from the first channel, and wherein the method further comprises:
applying, by a first decoding channel, a first decompression scheme to the first resulting compressed region data; and
applying, by a second decoding channel that s separate from the first decoding channel, a second decompression scheme to the second resulting compressed region data;
wherein the first decompression scheme and the second decompression scheme respectively mirror the first compression scheme and the second compression scheme.

11. An image processing system for compressing image data of an image, the image processing system comprising:
an image analyzer configured to
split the image data into regions, including a first region and a second region, and
determine a first compression scheme to he used in encoding the image data of the first region and a second compression scheme, different than the first compression scheme, to be used in encoding the image data of the second region; and
an encoder configured to
apply the first compression scheme to the image data of the first region and the second compression scheme to the image data of the second region;
wherein the image analyzer and the encoder are together configured to iteratively perform, for each region, the determining and the applying to yield first resulting compressed region data for the first region and second resulting compressed region data for the second region.

12. The image processing system of claim 11, wherein the first compression scheme is lossless and the second compression scheme is lossy.

13. The image processing system of claim 11, wherein the image analyzer is configured to determine respective compression schemes for all of the regions of the image data, and wherein the encoder is configured to apply the respective compression schemes to all of the regions of the image data, and wherein the image analyzer and the encoder are together configured to perform the determining and the applying iteratively until the compressed image data for the entire image is at or below a predetermined threshold file size value.

14. The image processing system of claim 13, wherein the image analyzer and the encoder are configured to perform the splitting, the determining, the applying and the iteratively performing for each image of a video stream of images, and wherein the predetermined threshold file size value is the same for all of the images of the video stream.

15. The image processing system of claim 13, wherein the image analyzer and the encoder are configured to perform the splitting, the determining, the applying and the iteratively performing for each image of a series of still images to be printed or displayed, and wherein the predetermined threshold file size value is the same for all of the images of the series.

16. The image processing system of claim 11, wherein, for the first region, at least one iteration of the determining includes determining a compression scheme based on a different compression method, yielding a different compression ratio, than was determined for the same region in a previous iteration of the determining.

17. The image processing system of claim 11, wherein, for the first region, each iteration of the applying includes applying the determined compression scheme to data resulting from a previous iteration of the applying for the first region.

18. The image processing system of claim 11, wherein, for each of the first and second regions, the determining of the compression scheme to be applied to the respective region is based on complexity of the region.

19. The image processing system of claim 11, wherein, for each of the first and second regions, the determining of the compression scheme to be applied to the respective region is based on whether the region includes text.

20. The image processing system of claim 11, wherein the applying of the first compression scheme is performed by a first encoding channel of the encoder, wherein the applying of second the compression scheme is performed by a second encoding channel of the encoder, separate from the first channel, and wherein the method further comprises:
applying, by a first decoding channel, a first decompression scheme to the first resulting compressed region data; and
applying, by a second decoding channel that is separate from the first decoding channel, a second decompression scheme to the second resulting compressed region data;
wherein the first decompression scheme and the second decompression scheme respectively correspond to the first compression scheme and the second compression scheme.
